(19) United States
(12) Patent Application Publication
(10) Pub. No.: US 2025/0068908 A1
(43) Pub. Date: Feb. 27, 2025

(54) APPARATUS AND METHOD FOR TRAINING BINARY DEEP NEURAL NETWORKS

(71) Applicant: HUAWEI TECHNOLOGIES CO., LTD., Shenzhen (CN)

(72) Inventors: Van Minh NGUYEN, Boulogne Billancourt (FR); Louis LECONTE, Boulogne Billancourt (FR)

(21) Appl. No.: 18/944,150

(22) Filed: Nov. 12, 2024

Related U.S. Application Data
(63) Continuation of application No. PCT/EP2022/062878, filed on May 12, 2022.

(51) Int. Cl. G06N 3/08

(52) U.S. Cl. CPC G06N 3/08

(57) ABSTRACT

A device for training a binary deep neural network, where the device includes a processor, is configured to: generate a training signal in dependence on an error between an output of a prototype version of the binary deep neural network and an expected output, the prototype version of the binary deep neural network having multiple binary weights each having a respective value; and in dependence on the training signal, output for each binary weight of the prototype version of the binary deep neural network a respective decision to invert or maintain the respective value of the respective binary weight. This may allow the device to train a deep neural network including binary parameters directly in the binary domain without the need for gradient processing methods.

### CROSS-REFERENCE TO RELATED APPLICATIONS

This application is a continuation of International Application No. PCT/EP2022/062878, filed on May 12, 2022, the disclosure of which is hereby incorporated by reference in its entirety.

### FIELD

The present disclosure relates to machine learning models and to the training of binary deep neural networks.

### BACKGROUND

Deep learning is the origin of numerous successes in the fields of computer vision and natural language processing during the last decade. It has occupied a central spot of technological and social landscapes, with applications going far beyond computer sciences.

Deep learning uses deep neural networks (DNNs), which are complex non-linear systems vaguely inspired by biologic brains, being able to manipulate high-dimensional objects, autonomously learn from given examples without being programmed with any task-specific rules, and obtain state-of-the-art performance.

FIG. 1 depicts the basic operation scheme of a DNN, which is usually split into two phases. In the training phase, the DNN, noted as ‘model’ in the figure, learns its own parameters. A starting version of the model to be trained, shown at 101, is trained using provided training data 102 to form trained model 103. Then, in the inference phase, the DNN is used to output one or more predictions 104 on unseen input data 105.

Deep neural networks are generally known as very intensive in terms of memory and computation. On one hand, DNNs are generally composed of a very large number of parameters, reaching hundreds of millions in today's applications. This requires a significant memory footprint for representing the model. On top of that, the training phase requires a large amount of training data and incurs a lot of other temporary variables used for optimizing the model weights (also referred to as parameters), such as gradient information. As a result, training a DNN generally requires a dedicated powerful infrastructure, which can limit the potential of artificial intelligence.

One promising approach for alleviating this memory wall issue is to design a DNN with binary parameters, meaning that the model parameters are represented by a binary number, consuming only 1 bit instead of a floating-point number of 32 bits. This would greatly reduce not only the model footprint, but also training memory and computation complexity.

However, binary parameters are discrete and cannot be optimized with the existing deep learning theory of gradient-descent (see, for example <<en.wikipedia.org/wiki/Gradient_descent>>).

To train binary deep neural networks, binarization is a prominent approach. FIG. 2 depicts a schematic operation diagram of this process, in which a floating-point model 201 is the starting DNN with floating-point parameters, and floating-point gradient-descent optimizer 202 is the block which optimizes the model floating-point parameters using gradient-descent principles. Binarization block 203 converts model parameters from floating-point into binary number form, for instance by using sign extraction subject to some predefined performance criteria. Binarized model 204 is updated during the training process and the final model obtained at the end of the training process is to be used for inference.

The main limitation of this solution is that the training phase completely relies on the floating-point training. Not only does it not solve the memory and computational complexity issues, but it also adds more complexity to the training process.

### SUMMARY

According to a first aspect, there is provided a device for training a binary deep neural network, the device including a processor, where the device is configured to: generate a training signal in dependence on an error between an output of a prototype version of the binary deep neural network and an expected output, the prototype version of the binary deep neural network having multiple binary weights each having a respective value; and in dependence on the training signal, output for each binary weight of the prototype version of the binary deep neural network a respective decision to invert or maintain the respective value of the respective binary weight.

This may allow the device to train and optimize a DNN comprising binary weights directly in the binary domain, without the need for gradient processing methods. As a result, the training process may require reduced memory and computational power because it avoids memory-intensive gradient signals as well as floating-point multiplication.

The device may be configured to generate the training signal in dependence on a predefined optimization target. This may allow the training signal to reflect how good the prototype version of the DNN is at predicting the outcome when compared with the expected outcome.

The predefined optimization target may be a minimization of a loss function. This may be a convenient implementation for training a deep neural network.

The training signal may include one or more quantities. The device may be configured to output the respective decision for each binary weight in dependence on the one or more quantities in order to meet the predefined optimization target. This may allow the device to use the training signal to determine whether or not to invert a particular weight in order to meet the predefined optimization target, for example in order to minimize a predetermined loss function.

The device may be further configured to track a status of the predefined optimization target. This may allow the device to incorporate the status of the optimized entity into the optimization signal during an iterative optimization process. This may allow the trained deep neural network to achieve better prediction accuracy during inference.

The respective decision to invert or maintain the respective value of each binary weight of the prototype version of the binary deep neural network may be based on an optimization signal computed in dependence on the training signal. This may allow the device to make a decision for inverting or maintaining each binary weight of the prototype version of the DNN.

Each binary weight may have only two possible values. This may allow the model parameters to be represented by a binary number, consuming only 1 bit instead of a floating-point number of 32 bits. This may reduce not only the model footprint, but also training memory and computation complexity.

The device may be configured to receive a set of training data for forming the output of the prototype version of the binary deep neural network, the set of training data including input data and respective expected outputs. The training signal may be formed in dependence on the error between the output of the prototype version of the binary deep neural network and the expected output. This may allow the prototype version of the binary DNN to process the input data to form a predicted output, which can then be compared to the respective expected output. This may allow the device to assess the performance of the prototype version of the binary DNN.

The device may further include a memory configured to store an accumulator that is updated in dependence on the predefined optimization target. This may allow control of the amount of binary weights to be inverted during each training iteration, so as to enhance the training convergence and performance.

The device may be configured to reset the memory in dependence on the respective decisions. For example, for each binary weight that is inverted in a particular iteration of the training process, the device may instruct a memory reset for a stored output of an accumulator function corresponding to that inverted weight. This may allow an accumulator to be reset each time a corresponding binary weight is inverted.

The device may be further configured to update the binary weights of the prototype version of the binary deep neural network in dependence on the respective decisions. This may allow the device to optimize the weights and update the DNN for use in the next iteration of the training process.

The device may be configured to iteratively update the binary weights of the prototype version of the binary deep neural network until a predefined level of convergence is reached. This may allow the resulting trained binary deep neural network to achieve a predefined level of performance during inference.

The binary deep neural network may be a Boolean deep neural network including Boolean neurons. Using a Boolean neuron design, Boolean layers and networks, such as linear layers and convolutional layers, may be constructed straightforwardly in the same way as floating-point layers and networks that are constructed from floating-point neurons.

According to another aspect, there is provided a method for training a binary deep neural network, the binary deep neural network including multiple binary weights, the method including: generating a training signal in dependence on an error between an output of a prototype version of the binary deep neural network and an expected output, the prototype version of the binary deep neural network having multiple binary weights each having a respective value; and in dependence on the training signal, outputting for each binary weight of the prototype version of the binary deep neural network a respective decision to invert or maintain the respective value of the respective binary weight.

This method may allow for the optimization or training of a DNN including binary weights directly in the binary domain without the need for gradient processing methods. As a result, the training process may require reduced memory and computational power because it avoids memory-intensive gradient signals as well as floating-point multiplication.

According to a further aspect, there is provided a computer readable storage medium having stored thereon computer readable instructions that, when executed at a computer system, cause the computer system to perform the method as set forth above. The computer system may include one or more processors. The computer readable storage medium may be a non-transitory computer readable storage medium.

### BRIEF DESCRIPTION OF THE DRAWINGS

The present disclosure will now be described by way of example with reference to the accompanying drawings.

In the drawings:

FIG. 1 schematically illustrates an operation scheme for a DNN;

FIG. 2 schematically illustrates binarization of a model trained using a floating-point gradient-descent optimizer;

FIG. 3 schematically illustrates the training of a binary DNN in the binary domain;

FIG. 4 depicts an example of processing flows and signals for one layer of a binary DNN;

FIG. 5 depicts a flowchart for an example of a method for training a binary DNN comprising multiple binary weights in accordance with embodiments of the present disclosure;

FIG. 6 depicts an example of a device for training a binary DNN in accordance with embodiments of the present disclosure; and

FIGS. 7(a) and 7(b) depict examples of results achieved using an embodiment of the present disclosure in terms of memory consumption and memory reduction, respectively.

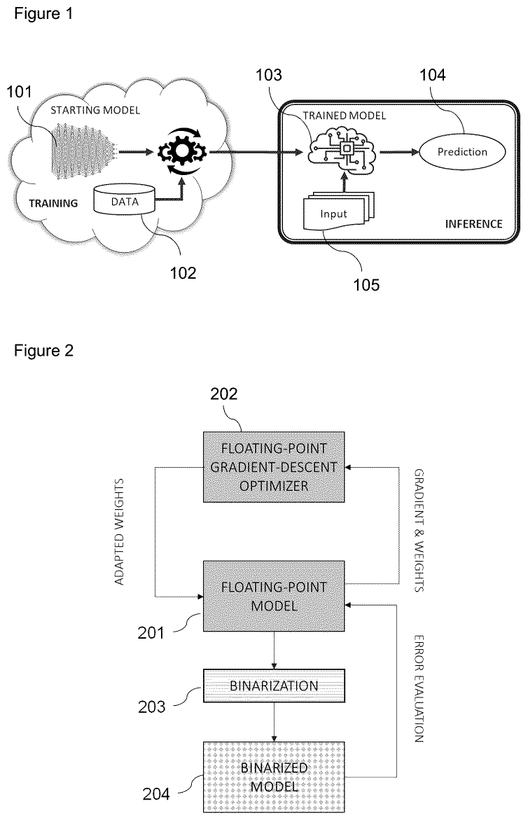

### DETAILED DESCRIPTION

A weight is a parameter within a neural network that transforms input data within the network's hidden layers. A neural network includes a series of nodes, or neurons. Within each neuron is a set of inputs, a set of weights and a bias value. As an input enters the node, it is multiplied by the respective weight value. It may optionally add a bias before passing the data to the next layer. The resulting output is either observed or passed to the next layer of the network.

Weights are learnable parameters within the network. A DNN may randomize the weights before learning initially begins. As training continues, the weights are adjusted toward the desired values to give the “correct” output.

Embodiments of the present disclosure can allow for the training and optimization of a DNN having binary weights directly in the binary domain without the need of gradient processing.

A ‘weight’ of a DNN may also be referred to as a ‘parameter’ interchangeably, having the same meaning herein.

Each binary weight has only two possible values. This can allow the model weights to be represented by a binary number, consuming only 1 bit instead of a floating-point number of 32 bits. This may reduce not only the model footprint but also training memory and computation complexity.

Given a binary DNN, logic rules can be established for taking a decision to invert or to keep each binary weight. Such logic rules make decisions by using signals computed from the binary model and subject to achieving a predefined optimization target, such as minimizing a learning loss function.

When a decision for inverting a binary weight is given, the binary weight is inverted from its current binary value to the other possible binary value. This avoids the combinatorics nature of discrete optimization problems, which is nondeterministic polynomial time hard (NP-Hard), and also takes the binary constraint as an advantage in that the binary parameter has only two values, such that inverting or maintaining the current value is a question that can be answered in a binary fashion.

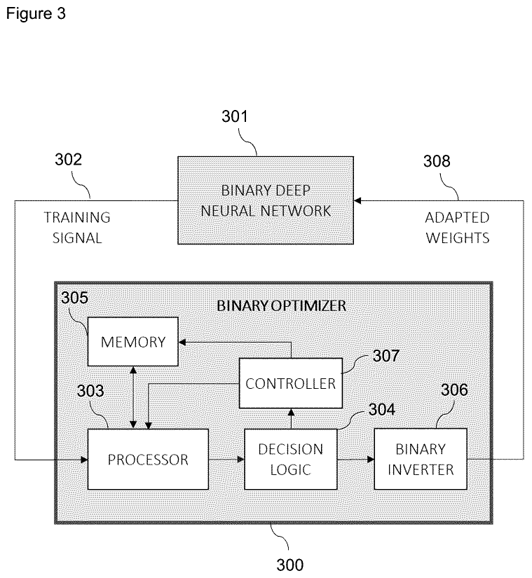

FIG. 3 shows an exemplary embodiment of the present disclosure. A binary optimizer is shown at 300.

Binary deep neural network 301 is the DNN to be trained. DNN 301 includes an input layer, an output layer, and one or more hidden layers. The DNN 301 has binary weights. Initially, the weights of the DNN 301 may be randomized.

The training process follows a standard iterative process, which iterates loops of a forward pass followed by a backpropagation pass. In the forward pass, training data is injected into a prototype version of the DNN (i.e. the current version of the DNN in that iteration of the training process) for evaluating the error between the output produced by the prototype version of the DNN and the true data labels. In the backward pass, the error is propagated from the output layer throughout the network, back to the input layer. This may be done in dependence on an optimization target, such as minimizing a predetermined loss function.

During this backpropagation, different information is computed, including a training signal, indicated at 302. For instance, in the standard full-precision DNN, training signals include the gradient of the loss function with respect to each quantity to be optimized.

In the implementation depicted in FIG. 3, the training signal 302 is generated in dependence on the error between the output of the prototype version of the binary deep neural network 301 and an expected output (the true data labels of the training data).

In dependence on the training signal, a respective decision is output for each binary weight of the prototype version of the binary deep neural network 301 to invert or maintain the respective value of the respective binary weight, as will be described in more detail below.

The training signal can include quantities which are specifically defined to express how a predefined optimization target, such as a loss function, varies when inverting a binary weight. The quantities are not necessarily real-valued signals. These training signals are sent to and used by the processor 303. The processor 303 is configured to implement at least a function that outputs an optimization signal from the received training signal of each binary weight, which is taken as input to the function. The optimization signal is then fed to the decision logic 304, as well as the optimizer memory 305.

Computation of the optimization signal from the training signal can be implementation-specific. One generic way of computing the optimization signal from the training signal is to compute an accumulation of the training signal over multiple iterations of the training process.

The decision logic 304 uses the received optimization signal to take a decision for inverting or keeping each binary weight of the current version of the DNN. Upon instruction from decision logic 304, the binary inverter 306 can perform binary inversion of a binary weight or can maintain its value.

The controller 307 can take control of the optimization process. For instance, it can take into account the decision made by the decision logic 304 to instruct a memory reset, or to adapt the way that the processor 303 computes the optimization signal. The controller 307 can also track the status of the optimization target.

The updated binary weights 308 are sent back to the binary DNN and the weights of the prototype version of the binary DNN 301 are updated as required, i.e. to invert those for which a decision has been output to do so, or maintain them.

In an exemplary embodiment, the binary DNN is a Boolean deep neural network which is made of Boolean neurons. A Boolean neuron has Boolean inputs b₁, b₂, . . . , bₘ and Boolean weights w₀, w₁, . . . , wₘ where m is the number of inputs, and in one particular example, outputs a Boolean value given as follows:

$$output = \{ \begin{matrix}TRUE , & if {w}_{0} + {\sum }_{i = 1}^{m} XOR ( {b}_{i} , {w}_{i} ) \geq T , \\ FALSE , & if {w}_{0} + {\sum }_{i = 1}^{m} XOR ( {b}_{i} , {w}_{i} ) < T ,\end{matrix}$$

wherein XOR is the Boolean exclusive-or logic, and T is a pre-defined threshold and in this example is set to T=(m+1)/2.

Using this Boolean neuron design, Boolean layers and networks, such as linear layers and convolutional layers, are constructed straightforwardly in the same way as floating-point layers and networks are constructed from floating-point neurons.

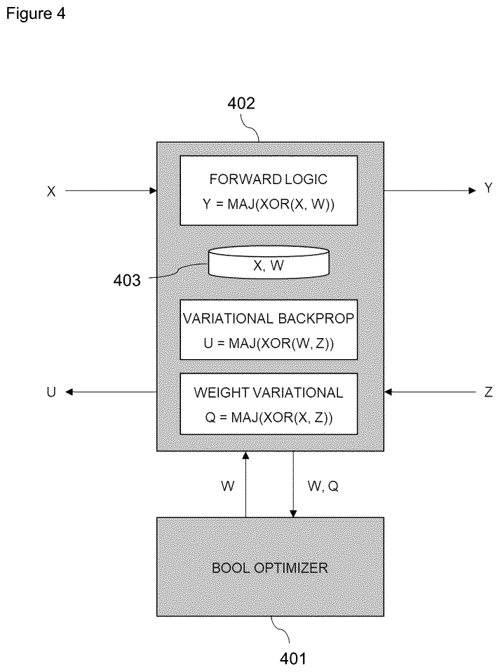

With the Boolean network described above, FIG. 4 shows an example of signals and flows in the processing of one layer of the binary DNN according to an exemplary embodiment. The Boolean optimizer is indicated at 401. A layer of the DNN is indicated at 402.

In FIG. 4, left-to-right arrows indicate forward processing, right-to-left arrows indicate backward processing, and arrows in vertical directions are between the layer 402 and the optimizer 401. In particular, where W is a weight, Z is the backpropagation signal which is received from a downstream layer, and U=MAJ(XOR(W, Z)) is the signal to be sent to an upstream layer. X is the feedforward input to the layer, and Y=MAJ(XOR (X, W)) is the signal to be sent to a downstream layer.

The weights W and the feedforward inputs X can be stored at the layer, as indicated at 403.

In this example, the training signal Q is given as Q=MAJ(XOR(X, Z)), in which XOR(X, Z) is element-wise XOR in appropriate matching dimensions of X and Z, and MAJ(A) is majority vote of Boolean array A which outputs TRUE if in A contains more TRUEs and FALSEs, and outputs FALSE otherwise.

In this example, for a Boolean neuron of XOR logic, the rule for optimizing a binary weight is ‘invert weight W if XOR(W, XOR(X, Z))=FALSE’. In this example, training signal is Q:=XOR(X, Z). This signal Q is a quantity used to determine whether or not to invert W in order to minimize the predefined loss function.

Other logic rules may alternatively be used to determine whether or not to invert W, as appropriate.

The training signal is therefore used to determine whether or not to invert the value of a binary weight in the prototype version of the binary DNN.

Going back to FIG. 3, in one example, the memory 305 stores an accumulator M. The controller 307 controls the optimizer operation. The controller 307 can specify a first scalar parameter ALPHA and a second scalar parameter BETA, which can be fixed or adapted during the training process, as required. ALPHA provides the ability to control the amount of binary weights to be changed in each iteration. BETA behaves like a forgetting parameter, which reflects the system evolution during the training process, mimicking the brain-plasticity phenomenon.

In one embodiment, the controller 307 adapts BETA in each training epoch as the ratio between the number of not-inverted binary weights to the total number of binary weights of the layer. Here, the number of not-inverted binary weights is obtained from the decision logic 304.

For each binary weight which is inverted in a particular iteration of the training process, the controller 307 can instruct a memory reset of value M of the accumulation corresponding to that inverted weight.

The processor 303 can perform M←BETA*M+ALPHA*Q, in which ‘*’ stands for the standard real-valued multiplication. The updated M for an inverted weight is stored in the memory 305.

The decision logic 304 gives an inversion instruction of weight W if W=True and M>=1, or M=False and M<=−1.

The binary inverter 306 executes W=NOT W upon an inversion instruction. The values of the weights are then updated in the prototype version of the DNN 301 for use in the next training iteration. Alternatively, if the trained model has converged, the DNN with those updated weights is used for the inference phase.

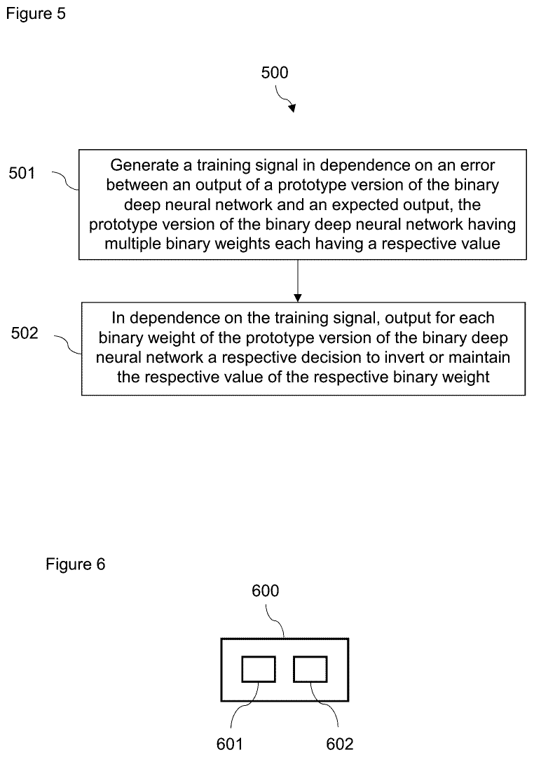

FIG. 5 shows an example of a method for training a binary deep neural network in accordance with embodiments of the present disclosure. As described above, the binary deep neural network includes multiple binary weights. At step 501, the method includes generating a training signal in dependence on an error between an output of a prototype version of the binary deep neural network and an expected output, the prototype version of the binary deep neural network having multiple binary weights each having a respective value. At step 502, the method includes, in dependence on the training signal, outputting for each binary weight of the prototype version of the binary deep neural network a respective decision to invert or maintain the respective value of the respective binary weight.

FIG. 6 shows an example of a device configured to implement the above methods.

The device 600 may include at least one processor, such as processor 601, and at least one memory, such as memory 602. The memory stores in a non-transient way code that is executable by the processor(s) to implement the device in the manner described herein.

The device 600 may also be configured to implement a binary deep neural network trained according to the method 500, with optional additional features as described with respect to the above embodiments. This may allow the device to perform inference using the binary DNN for a variety of tasks.

An advantage of the approach described herein is that it allows to train a binary DNN directly in the binary domain without the need for a floating-point (or full-precision) gradient, resulting in multiple-time factor of memory and computational complexity reduction, while approaching prediction accuracy of the full-precision training, as illustrated in Table 1 below. Table 1 includes the test accuracy on the Canadian Institute for Advanced Research image dataset (CIFAR10) with Visual Geometry Group (VGG) small architecture, using a batch size of 100.

TABLE 1

| Type | Method | Test Acc. (%) |
|---|---|---|
| BINARY- | Present method | 89.5 |
| TRAINED | | |
| FULL-PRECISION | Binarized Neural Network | 89.9 |
| TRAINED | XNOR-Net | 89.8 |
| BINARIZATION | Loss-Aware Binarization | 87.7 |
| | Differentiable Soft Quantization | 91.7 |
| FULL-PRECISION | Optimized Full-Precision | 93.8 |

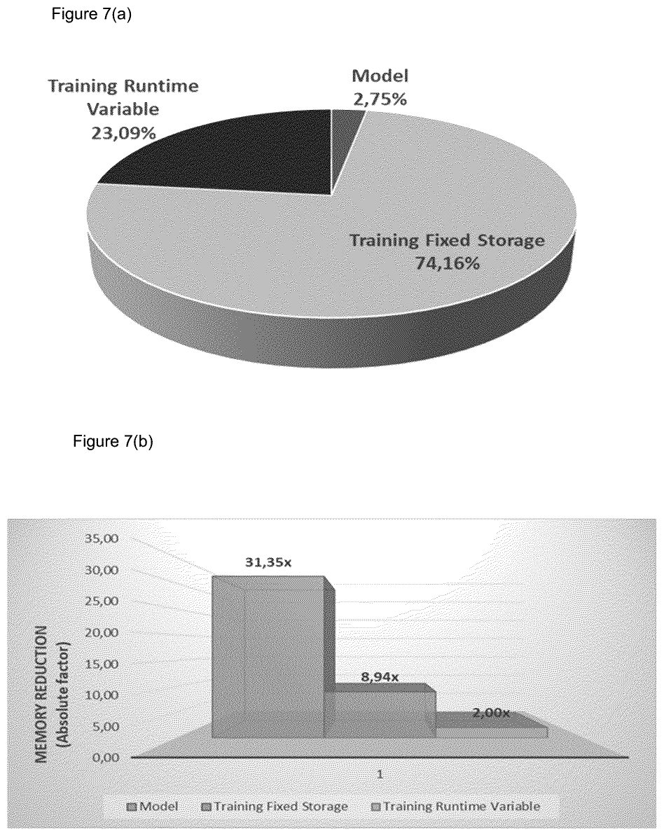

FIGS. 7(a) and 7(b) exemplify advantages of the exemplary embodiment described above in terms of memory consumption and memory reduction, respectively, compared to the full-precision training.

Embodiments of the present disclosure can therefore allow for the training and optimization of binary DNNs directly in the binary domain without the need of a gradient. Compared to existing solutions, which require DNNs to compute gradient signals, the training process of the present disclosure requires much less memory and computational power because it avoids memory-intensive gradient signals. The approach is native to deep architectures.

The method of the present disclosure works directly on binary weights of the binary DNN. Existing solutions require two versions of each quantity (a full-precision version and a binarized one), such as weights and a neuron's input and output. Avoiding full-precision signals, as in the training process described herein, requires much less memory and computational power.

The optimizer controller reflects the decision results on the processor and memory and allows the binary training process to achieve better prediction accuracy. This is an innovative component which incorporates the status of the optimized entity into the optimization signal during the iterative optimization process. This can allow the binary training process to achieve better prediction accuracy.

The present disclosure describes in isolation each individual feature described herein and any combination of two or more such features, to the extent that such features or combinations are capable of being carried out based on the present disclosure as a whole in the light of the common general knowledge of a person skilled in the art, irrespective of whether such features or combinations of features solve any problems disclosed herein, and without limitation to the scope of the claims. The present disclosure may consist of aspects of any such individual feature or combination of features. In view of the foregoing description it will be evident to a person skilled in the art that various modifications may be made within the scope of the present disclosure.

What is claimed is:

1. A device for training a binary deep neural network, the device comprising a processor, wherein the device is configured to:
generate a training signal in dependence on an error between an output of a prototype version of the binary deep neural network and an expected output, the prototype version of the binary deep neural network having multiple binary weights each having a respective value; and
in dependence on the training signal, output for each binary weight of the prototype version of the binary deep neural network a respective decision to invert or maintain the respective value of the respective binary weight.

2. The device of claim 1, wherein the device is configured to generate the training signal in dependence on a predefined optimization target.

3. The device of claim 2, wherein the predefined optimization target is a minimization of a loss function.

4. The device of claim 2, wherein the training signal comprises one or more quantities and wherein the device is configured to output the respective decision for each binary weight in dependence on the one or more quantities in order to meet the predefined optimization target.

5. The device of claim 2, wherein the device is further configured to track a status of the predefined optimization target.

6. The device of claim 1, wherein the respective decision to invert or maintain the respective value of each binary weight of the prototype version of the binary deep neural network is based on an optimization signal computed in dependence on the training signal.

7. The device of claim 1, wherein each binary weight has only two possible values.

8. The device of claim 1, wherein the device is configured to receive a set of training data for forming the output of the prototype version of the binary deep neural network, the set of training data comprising input data and respective expected outputs.

9. The device of claim 2, wherein the device further comprises a memory configured to store an accumulator, wherein the accumulator is updated in dependence on the predefined optimization target.

10. The device of claim 9, wherein the device is configured to reset the memory in dependence on the respective decisions.

11. The device of claim 1, wherein the device is further configured to update the binary weights of the prototype version of the binary deep neural network in dependence on the respective decisions.

12. The device of claim 11, wherein the device is configured to iteratively update the binary weights of the prototype version of the binary deep neural network until a predefined level of convergence is reached.

13. The device of claim 1, wherein the binary deep neural network is a Boolean deep neural network comprising Boolean neurons.

14. A method for training a binary deep neural network, the binary deep neural network comprising multiple binary weights, the method comprising:
generating a training signal in dependence on an error between an output of a prototype version of the binary deep neural network and an expected output, the prototype version of the binary deep neural network having multiple binary weights each having a respective value; and
in dependence on the training signal, outputting for each binary weight of the prototype version of the binary deep neural network a respective decision to invert or maintain the respective value of the respective binary weight.

15. The method of claim 14, further comprises:
generating the training signal in dependence on a predefined optimization target.

16. The method of claim 15, wherein the predefined optimization target is a minimization of a loss function.

17. The method of claim 15, wherein the training signal comprises one or more quantities and wherein the device is configured to output the respective decision for each binary weight in dependence on the one or more quantities in order to meet the predefined optimization target.

18. The method of claim 15, further comprises:
tracking a status of the predefined optimization target.

19. The method of claim 14, wherein the respective decision to invert or maintain the respective value of each binary weight of the prototype version of the binary deep neural network is based on an optimization signal computed in dependence on the training signal.

20. A non-transitory computer-readable storage medium having stored thereon computer-readable instructions that, when executed at a computer system, cause the computer system to perform the steps of:
generating a training signal in dependence on an error between an output of a prototype version of the binary deep neural network and an expected output, the prototype version of the binary deep neural network having multiple binary weights each having a respective value; and
in dependence on the training signal, outputting for each binary weight of the prototype version of the binary deep neural network a respective decision to invert or maintain the respective value of the respective binary weight.
